(19) United States
(12) Patent Application Publication
(10) Pub. No.: US 2011/0219003 A1
(43) Pub. Date: Sep. 8, 2011

(54) DETERMINATION OF PASSAGES AND FORMATION OF INDEXES BASED ON PARAGRAPHS

(76) Inventor: Jiandong BI, Harbin (CN)

(21) Appl. No.: 13/108,664

(22) Filed: May 16, 2011

Related U.S. Application Data
(63) Continuation-in-part of application No. 11/580,346, filed on Oct. 16, 2006, now abandoned.
(60) Provisional application No. 60/728,372, filed on Oct. 20, 2005.

(51) Int. Cl. G06F 17/30

(52) U.S. Cl. 707/739; 707/E17.047; 707/E17.002

(57) ABSTRACT

A method for retrieving information from a document includes a process of grouping paragraphs in the document to form passages, and forming indexes relating to a number of words in the passages. The number of paragraphs in a passage is determined based on the number of paragraphs considered optimum for a writer to cover a particular topic. Passages are formed by merging each N consecutive paragraphs in the document, where N is an integer greater than 1. Thus, individual passages may include paragraphs that are identical to other passages.

### CROSS-REFERENCE TO RELATED APPLICATIONS

This application is a continuation-in-part of application Ser. No. 11/580,346, filed Oct. 16, 2006, now pending. The patent application identified above is incorporated here by reference in its entirety to provide continuity of disclosure.

### FIELD OF THE INVENTION

The invention relates to a method of retrieving information from documents.

### BACKGROUND OF THE INVENTION

The present invention relates generally to the field of natural language processing, and more particularly to the field of information retrieval. Currently there are great amounts of electronic documents existing, which still increase continually. How to search information from these documents in a precise manner turns into a crucial issue. The process of information retrieval generally gets started with typing a query, and then the retrieval system searches information relevant to the query in a document library (or document set), and returns the results to user.

A typical method of information retrieval is to compare document and query, the document containing more words included in the query is deemed to have a higher relevance to query. Conversely the document containing less number of words included in the query is deemed to be less relevant to said query. Documents with high relevance are retrieved. Retrieval methods by comparing words of an entire document with a query to evaluate relevance are generally referred to as document-based retrieval methodology. A document, in particular, a long document, may contain several dissimilar subjects. On this account the comparative result may not precisely reflect the relevance. It may be the case that long documents contain a greater number of words, i.e., the document has a higher possibility to contain words included in the query. In such a case irrelevant documents appear as relevant. Another possible case is that there exists one subject relevant to query in the document. However, the document still contains other subjects, and the proportion of words identical to the query in said document to the total words of the whole document is not high (Proportion-based evaluation of relevance is a typical method), accordingly the relevance of the document to query is low.

A passage is a partial document. Passage retrieval is to estimate the relevance of a document (or passage) to query based on the comparison of a partial document with query. Passage retrieval considers only partial document. In addition to the defects of document-based retrieval, accordingly passage retrieval is likely to be more precise than document-based retrieval. For example, if a document containing 3 subjects is divided into 3 passages, and if each contains one subject, passage retrieval should be more precise than document-based retrieval. The bottleneck problem for passage retrieval is how to divide a document into passages.

One method is to form passage by the paragraph of the document. James P. Cllan uses bounded-paragraph as a passage, which is actually pseudo-paragraph of 50 to 200 words in length, formed in such a way to merge short paragraphs and fragment long paragraphs. For details refer to James P. Cllan, “Passage-Level Evidence in Document Retrieval”, Proceedings of the Seventeenth Annual International ACM-SIGIR Conference on Research and Development in Information Retrieval (SIGIR 93) Springer-Verlag, 1994, pp. 302-310.

J. Zobel et al. presents a type of passage, which is referred to as a page. A page is formed by repeatedly merging a paragraph until the bytes of document block resulting from said merge is greater than a certain number. Refer to J. Zobel, et al., “Efficient retrieval of partial documents”, Information Processing and Management, 31(3):361-377, 1995; This paper authored by Zobel defines that a page shall be merged to at least 1,000 bytes.

Windows-based passages divide a document into segments with an identical number of words. Each segment is a passage. Referring to James P. Cllan, “Passage-Level Evidence in Document Retrieval”, Proceedings of the Seventeenth Annual International ACM-SIGIR Conference on Research and Development in Information Retrieval (SIGIR 93) Springer-Verlag, 1994, pp. 302-310; In this paper, Callan recommends to use 200- or 250-word passages, i.e., a segment with a length of 200 or 250 words is taken as a passage, and half of the length between adjacent passages is overlapped.

These methods referred to above all divide a document into passages of identical length or approximately identical length. But the degree of “sparseness and denseness” of each document is different, namely, when expressing a thought or topic, some persons may use more words, and the document segment formed corresponding to the thought or topic is long. Some persons may be used to a terse expression manner, while expressing the same thought or topic, they use fewer words, and the document segment formed corresponding to the thought or topic is short. So dividing all documents into passages of a single length has drawbacks.

### SUMMARY OF THE INVENTION

The present invention mainly relates to a new method of forming passages. The method considers the degree of sparseness and denseness of a document. The method is as follows: each N consecutive paragraphs of a document form a passage, wherein N is a number greater than 1. Among the passages formed by the method, individual passages possibly have overlap, namely, individual passages possibly contain identical paragraphs. A particular passage can at most have N−1 paragraphs that are identical to another paragraph. This method corresponds to a window that moves over a document. The window contains N paragraphs. Each time, the window moves down a paragraph, and each time, the window forms a passage. If a document contains less than N paragraphs, then the document is not partitioned. The whole document will consist of a single passage.

For example, if N is set to 3 and a document contains 5 paragraphs, from the 1st paragraph to 3rd paragraph is a passage (assume the passage is referred to as the first passage), from the 2nd paragraph to 4th paragraph is a passage (assume the passage is referred to as the second passage), from the 3rd paragraph to 5th paragraph is a passage (assume the passage is referred to as the third passage). Among the passages formed, the first passage and the second passage contain 2 identical paragraphs, the first passage and the second passage all contain 2nd paragraph and 3rd paragraph, namely, the first passage and the second passage have overlap. In the same way, the second passage and the third passage both contain the 3rd paragraph and the 4th paragraph. On the other hand, if N is set to 3, and the document contains 2 paragraphs, the document is not partitioned. The whole document will consist of a single passage.

When learning to write, people are taught to express a single thought or topic in a paragraph and begin a new paragraph after a topic or thought is expressed. If a person likes a terse expression manner, he perhaps expresses a thought or topic using fewer words. Therefore the paragraph formed may be short. A person who isn't terse may use more words to express a thought. So the paragraph formed may be long. A paragraph reflects the degree of “sparseness and denseness” of an article. Though people are taught to express a thought or discuss a topic in one paragraph, people can't carry out this rule precisely, namely people can't delimit paragraphs precisely (substantially most circumstances is such). While expressing a thought in a paragraph, people may “leak” the thought outside the paragraph, namely leak a thought to the next paragraph, even again next paragraph. If the scope of “leak” does not exceed N paragraphs, namely, if everybody (or the majority of people) use no more than N paragraphs to express a thought or discuss a topic, then it should be a good method to form a passage by uniting N consecutive paragraphs, for in passage retrieval, the objective forming a passage is to make the passage (just) contain a topic. Certainly a topic or thought maybe doesn't exactly correspond to N paragraphs. It perhaps corresponds to 1 paragraph, 2 paragraphs, . . . , N−1 paragraphs or N paragraphs among N paragraphs. But N paragraphs are shorter than the whole document (in the case where the document contains more than N paragraphs), so retrieving based on N paragraphs may get a higher precision than on a whole document. Again, each N consecutive paragraphs forms a passage, so each topic contained in the document have a passages corresponding to it, namely, if a document contains a certain subject, then there must be a passage to contain it. Just as previously described, the method forming passages in the present invention corresponds to existing a window that moves over a document, the window contains N paragraphs, if the expression of each topic does not exceed N paragraphs, and the window moves down a paragraph each time, then the window should be able to “move” through all topics that the document includes, namely each topic in the document has corresponding window that encloses it. As the window boundary is at a boundary of a paragraph (at the beginning or end of a paragraph), the circumstance doesn't exist that a topic is partitioned. If a window boundary is inside a paragraph (not at the beginning or end of a paragraph), then a topic may be partitioned according to the above-mentioned reason (generally people express a topic in a paragraph). This can't guarantee that all topics in a document have corresponding passages. In the present invention, although the number of paragraphs included in a passage is fixed, the passage length isn't fixed. If a document is written in a verbose style, then the document is “sparse”, the words is more which are used to express a topic, then corresponding paragraph may be longer and passage is also longer. If a document is written in a terse style, then the document may be “dense”, the words is fewer which are used to express a topic, then corresponding paragraph may be shorter and passage is also shorter.

Certainly, perhaps such N doesn't exist that makes the expressions of all topics not to exceed N paragraphs. But if the expressions of the majority (even great majority) of topics do not exceed N paragraphs, then such a method forming passages still can show high precision (on the statistics). This has been confirmed in the test for the system implementing the present invention. Namely, such N exists that produces high precision retrieval. In the present invention, the preferred value of N is from 2 to 30, and more preferably the value of N is 6.

In the implementation of the present invention, an information retrieval system is developed. The information retrieval system is referred to as the system of this invention thereinafter. This information retrieval system comprises an index generation phase, and a document search phase (which is called search phase for short thereinafter) in which relevant documents are searched based on the query. An index is an indication of the relationship between documents and words. Most generally, an index shows occurrence times and position of words in documents. In the present invention, an index is a set of Document Number-Word Number pairs. Each pair is referred to as an index entry. Document Numbers represents a specific document, Word Numbers represents the number of times the word appears in this document, i.e., the number of times that word exists in this document. For example, provided that the index of word “sun” is <(2, 3), (6, 2), (8, 6)>, this means that the word “sun” appears 3 times in No. 2 document (that is to say there are 3 suns in No. 2 document), 2 times in No. 6 document and 6 times in No. 8 document. In index entries, Document Number referred to can also be expressed by the difference between Document Numbers, i.e., the difference between the Document Number of the latter entry and that of the previous one. For example, the above index of word “sun” can be expressed as <(2, 3), (4, 2), (2, 6)>, where the position of Document Number of the second index entry is 4 (which is the difference of the Document Number of the second original index entry and that of the first one), the position of Document Number of the third index entry is 2 (which is the difference of the Document Number of the third original index entry and that of the second one). In the present invention, passage retrieval is used, so actually the difference of passage numbers is used in the position of the Document Number, i.e., the first number of an index entry is the difference of passage numbers. The second number of an index entry represents the number of times a word appears in the passage indicated by the first number of the index entry.

In the present invention, a passage contains N paragraphs, so the word number of an index entry (the second component of an index entry) is the number of times that a word occurs in N paragraphs. Such an index substantially means that while comparing a document with query in document search phase, the system is to compare the words in the scope of N paragraphs with query. In addition, among the passages formed by the method of the present invention, passages possibly have overlap. Passages at most have N−1 paragraphs that overlap. This also means that while comparing a document with the query, a window moves down a paragraph each time, which particularly means that the passages pointed to by the first component of index entries have overlap. The relevance of a document to the query is estimated mainly by an index in the document search phase. The characteristic of the information retrieval method is substantially reflected by index. In fact index implicitly indicates which part of the document is compared with the query. In addition, distribution and overlap of passages are implicitly reflected by index. From a certain angle, index can be regarded as another form of documents (or passages). This kind of form removes the information that is irrelevant to the process to be executed. For example, in the implementation of the present invention, index can be regarded as another form of passages. In this kind of form, the position information of words in passages is removed. The information of the number of times that words occur in passages is reserved, for only the information of the number of times that words occur is needed in the latter document search phase. Some information retrieval systems need the position information of words. There the index may include the position information of words in documents. Therefore, the index of the present invention may be the same as the index of other type of passages in form, but they are different in the significance and effect. Just as described above, index is another kind of manner of expressing documents (or passages), so the index of the present invention is different from the indexes formed based on whole documents (they can be regarded as representing whole documents) and other types of passages (they can be regarded as representing those kinds of types of passages). Just based on such index, a high precision is gotten in latter document search phase, so the index produced by the method of the present invention is novel and useful.

The index generation process is as described below: A document is taken out from a document set, then the system analyses the document and determines the passages that the document includes. In the document, each N consecutive paragraphs form a passage. In the specific implementation of the present invention, after each N consecutive paragraphs in a document form a passage, again the system takes the first N−1 paragraphs of the document to form a passage which is referred to as the first passage, takes the last N−1 paragraphs of the document to form a passage which is referred to as the last passage. The reason for taking N−1 paragraphs at the beginning and end of a document again to form passages is that this gets a good accuracy in practice. Intuitive explanation of the method is: in middle of a document, topic discussed in a paragraph can be “leaked” in two directions—upwards and downwards, namely, the topic discussed in the paragraph possibly is discussed in the previous paragraph and the following paragraph, but at the beginning and the end of a document, a topic can be leaked only towards a direction, namely, the topic discussed in the first paragraph possibly is discussed only in the following paragraph, the topic discussed in the last paragraph possibly is discussed only in the previous paragraph. Taking N−1 paragraphs respectively at the beginning and end of a document to form two passages should be understood as a selective step of the implementation of the present invention, not a necessarily included step. In the specific implementation of the present invention, a paragraph is recognized by written form. For example, a method recognizing paragraphs is by indent. Each indent is considered as a beginning of a paragraph. In the specific implementation of the invention, paragraphs are paragraphs in broad sense. If there is an indent at the beginning of a title or abstract, then the title or abstract is regarded as a paragraph. Herein, only for illustrating the method recognizing paragraphs, the present invention is not limited to recognize paragraphs only by indent. The written form of paragraphs also have other forms, for example, there is a blank line between paragraphs etc. Just as previously described, the method forming passages in the present invention is: in a document, each N consecutive paragraphs form a passage, at the beginning and end of the document, respectively form a passage again that contains N−1 paragraphs. If a document contains less than N paragraphs, then the document is not partitioned, the whole document is a passage. In the present invention, the preferred value of N is from 2 to 30, and more preferably the value of N is 6. After a passage is determined (assume the number of the passage is P), Each (different) word appearing in the passage will result in the generation of an index entry. Assume W is a word appearing in P, then W result in the generation of an index entry. The first component of the index entry is the difference between P and the number of a previous passage in which W appeared (If W occur for the first time, then the first component of W's index entry is P). The second component of W's index entry is the occurrence number of W in P.

The index finally generated by the system of this invention is stored on a hard disk. During generation of indexes, if each index entry created needs to be stored in a corresponding position on a hard disk, it may likely require random access, which is time-consuming, resulting in a very slow index creation process. Total indexes created cannot be temporarily stored in memory as currently most PCs have 1G to 2G of memory. The index of a 5G set of document can occupy up to 400M after compressed, in real world, the document set is larger, the index generated by such document set will exceed memory capacity. On this account, the system of this invention adopts a compromise. An index entry is temporarily stored in memory whenever it is generated. The index in memory is merged to the overall index file when the index length exceeds a certain length Max_PIndex_L, i.e., stored to hard disk. In the specific implementation of the present invention, Max_PIndex_L is set to 30 M. Setting Max_PIndex_L to 30 M is only a specific implementation of this invention, shouldn't be understood as a restriction. Since the index in memory is not the full index, but only a part of the full index. It is formed by some passages among all passages, i.e., this index is “partial”, therefore we call the index a partial index. Hereinafter the passages forming a partial index are referred to as a block. For the purpose of easy identification, we call the index finally generated for all passages general index. In the system of this invention, the main process of index generation is to repeatedly generate partial indexes, and then link the partial indexes into general index. Upon the completion of processing all documents (or passages), general index is formed.

The system of this invention generates indexes by scanning the document set in two passes. The first time scan mainly records the index length of each word, with which the initial position of the index of each word can be computed. The philosophy is such that the initial point of the index of following words is the sum of the index lengths of all previous words (previous words are the words which occur in advance). For easy access of index, in the specific implementation of the invention, the initial point of the word index in general index must start from an integral byte, if not, the initial point will be adjusted to get start from an integral byte. In the specific implementation of the invention, index length is represented by bit rather than byte. After the initial position of the index of each word is gotten from the first time scan. Space can be pre-allocated. Partial index is stored in memory, general index is stored in hard disk, so the memory space can be pre-allocated for partial index, and hard disk space can be pre-allocated for general index such that the index entries of words can be stored to respective positions during the second time scan.

In the first time scan, two types of index lengths are recorded, one is the length of index of each word in general index, and the other is the length of index of words in each partial index. During the generation process of general index, a number of partial indexes are likely generated, and the length of index of a word is different in different partial index, consequently a partial index parameter list is set up which records some parameters of each partial index, including the number of passages forming each partial index, lpsg_num, partial index length BlkInvLen, word number WrdNum which is the total number of (different) words appeared up to now (namely, by the time the present partial index is formed), not only the number of words appearing in the block forming the present partial index. The reason for using all words appeared up to now is as follows: if the words only appearing in the block are used, as the words appearing in different blocks may be different, for each block, the words appearing in it may need to be record, this may need to record a number of set of words. If all words appeared up to now are used, then only words appeared up to now need to be recorded, namely only one set of words need to be recorded. It can be determined by the partial index parameters (the number of index entries and the length of index) of the word whether a word appears in a block. The partial index parameter list also includes the number of index entries and index lengths of each word in partial index. Each Word referred to herein also refers to all words appearing up to now, and not merely those words appearing in a block. If a word does not appear in a block, the word's number of index entries and index lengths corresponding to the partial index formed by this block are both 0. This become clearer in the subsequent discussion of FIG. 3A and FIG. 3B.

The first time scan does not generate any index, only computes some parameters of word index, including number of index entries and length of word index (for general index and partial index). These parameter records are preparation for practical generation of indexes for the second time scan. Initial point of index of each word can be determined from index length of its previous words. Essentially the first time scan is mainly to predetermine the length of word index, including the length in partial index and that in general index. Getting known of the index length of each word will find the initial point of the index of each word by calculation. The philosophy is that the initial point of the index of word followed is the sum of index lengths of all previous words. During the practical generation of an index for the second time scan, firstly the partial index is generated, which is stored in memory, and then the partial index is linked to general index. This process is repeated until general index is generated. The second time scan finally forms a dictionary, too. The dictionary contains words, the number of index entries for each word, the initial point of the index of each word in general index, and the length of the index of each word in general index. In search phase, the index information of the words in query can be gotten by consulting the dictionary.

In the specific implementation of the present invention, an instruction is provided to form passages and produce index. This instruction has an input parameter, the parameter is the number of paragraphs that a passage contains, namely the above-mentioned N. In the specific implementation of the present invention, the document set is stored in a fixed folder, so the folder is not as a parameter of the instruction. Storing the document set in a fixed folder is only a specific implementation of the present invention, shouldn't be understood as a restriction.

Upon generation of an index, the system will search relevant documents in terms of the query. In the specific implementation of the present invention, a ranked-query is adopted, i.e., the query is compared with all passages, and then the passages and documents are ranked by relevance from high to low. A ranked-query is different from a Boolean query. A Boolean query generally is a Boolean expression. The documents satisfying the Boolean expression are regarded as the retrieved, the documents are returned. No ranking of the retrieved documents is provided, namely, a document either satisfies the Boolean query (in which case it is retrieved) or it does not (in which case it is not retrieved). In the specific implementation of the present invention, the cosine degree of similarity is used to estimates the relevance of each passage to query, wherein the more the cosine value is, the higher the relevance of a passage to query is; contrarily the less the cosine value is, the lower relevance of a passage to query is. The passage with more cosine values ranks ahead, the one with less value ranks rearwards. Finally the passages are ranked in terms of their cosine values from high to low. The output of the system of this invention is documents, not passages. The ranking of a document is determined by the rank position of the passage it includes with the highest cosine value. For example, provided that P1 is a passage in document D1, in all the passages that D1 contains, P1 is the highest-ranked. P2 is a passage in document D2, in all the passages that D2 contains, P2 is the highest-ranked. If P1 ranks in the front of P2, then the document D1 ranks in the front of the document D2. The computing formula of cosine degree of similarity is as below:

$$\begin{matrix}cos ine ( Q , {PSG}_{p} ) = \frac{1}{{W}_{p} {W}_{q}} {\sum }_{t ∈ Q ⋂ {P}_{p}} ( 1 + {log}_{e} {f}_{p , t} ) \cdot {log}_{e} ( 1 + \frac{M}{{f}_{t}} ) & ( 1.1 ) \\ {W}_{p} = \sqrt{{\sum }_{t = 1}^{n 1} {( 1 + {log}_{e} {f}_{p , t} )}^{2}} & ( 1.2 ) \\ {W}_{q} = \sqrt{{\sum }_{t = 1}^{n 2} {[ {log}_{e} ( 1 + M / {f}_{t} ) ]}^{2}} & ( 1.3 )\end{matrix}$$

To facilitate the description hereinafter, we denote the summation in formula (1.1) as Sp, i.e.,

$${S}_{p} = {\sum }_{t ∈ Q ⋂ {PSG}_{p}} ( 1 + {log}_{e} {f}_{p , t} ) \cdot {log}_{e} ( 1 + \frac{M}{{f}_{t}} ) \qquad ( 1.4 )$$

In the formula, Q represents query, PSGp represents Number p passage, cosine (Q, PSGp) represents the cosine degree of similarity of query and Number p passage, cosine value represents the matching degree of Q and PSGp, fp,t represents the number of word t appeared in Number p passage, ft represents the number of passages where word t appears, M represents the total number of all passages, n1 represents the number of different words appeared in Number p passage, n2 represents the number of different words appearing in the query. Long queries and long documents contain more words, the summation value Sp may be greater than that of short query and short document, therefore in the formula it is divided by Wp and Wq for the purpose of eliminating the effect. Wq is identical for a query and the objective herein is only to compare the magnitude for ranking. On this account Wq can be removed from the formula.

It is should be understood as a specific implementation of the present invention rather than a restriction to estimate the relevance of documents to query in terms of the cosine degree of similarity.

In the implementation of the present invention, an instruction is provided to compute Wp. The instruction compute Wp by general index produced in the index generation phase. The instruction computes Wp of each passage and stores them into hard disk. The specific procedure to compute Wp is described below. In the specific implementation of the present invention, the filename storing general index and the filename storing Wp are all fixed, so the two filename needn't be as parameters of the instruction.

In the implementation of the present invention, another instruction is provided to execute the function to search documents. The instruction searches the documents that are thought to be relevant to query. A certain number of documents are returned after searching. The number of documents to be returned is set in the instruction. The instruction has two parameters, the first parameter is the number of documents to be returned, the second parameter is query. The instruction is referred to as search instruction thereinafter.

When the system of this invention establishes an index and searches documents, stemming shall be done for each word. For example, regarding the significance, book and books are the same word, but they appear as two words regarding the written forms due to the difference of singular and plural forms, however, after stemming, books is converted to book (suffix s is removed), two words turn into the same one, when the system of this invention establishes index, the calculation of occurrence number of a certain word is actually to compute the occurrence number of word (actually the stem) upon the completion of stemming. For example, on the assumption that a document (or passage) contains 1 book and 1 books, without stemming, the occurrence number of book is 1; whereas after stemming, the occurrence number of book is 2. In the document search phase, stemming shall also be done for words in query. For stemming methods adopted by the system of this invention, refer to Porter, M. F., “An algorithm for suffix stripping”, Program, 14(3): 130-137, 1980. In the description and diagrams hereinafter, word refers to stemming processed word, unless otherwise specified. Stemming is carried out when reading each word, every time when reading a word, accordingly it will be stemming processed.

### BRIEF DESCRIPTION OF THE DRAWINGS

FIG. 1 is a structural drawing which shows the specific environment implementing this invention.

FIG. 2 is a schematic diagram showing the relations between general index, document (or passage) and partial index.

FIG. 3A and FIG. 3B together are the flow diagrams of the first time scan during the index generation phase.

FIG. 4 is a schematic diagram of partial index parameter list.

FIG. 5A and FIG. 5B together are the flow diagrams of the second time scan during the index generation phase.

FIG. 6 is a schematic diagram of dictionary's structure in memory.

FIG. 7 is a schematic diagram of dictionary's structure in hard disk.

FIG. 8 is a schematic diagram showing the link of partial index into general index.

FIG. 9 is a flow diagram for determining passages and indexes of words in the passage.

FIG. 10 is a schematic diagram showing the manner forming passages.

FIG. 11 is a flow diagram for computing Wp.

FIG. 12A and FIG. 12B together are flow diagrams of document search phase.

FIG. 13 is a flow diagram for computation of Sp (for calculation of Sp, refer to Formula 1.4).

### DETAILED DESCRIPTION OF THE PREFERRED EMBODIMENTS

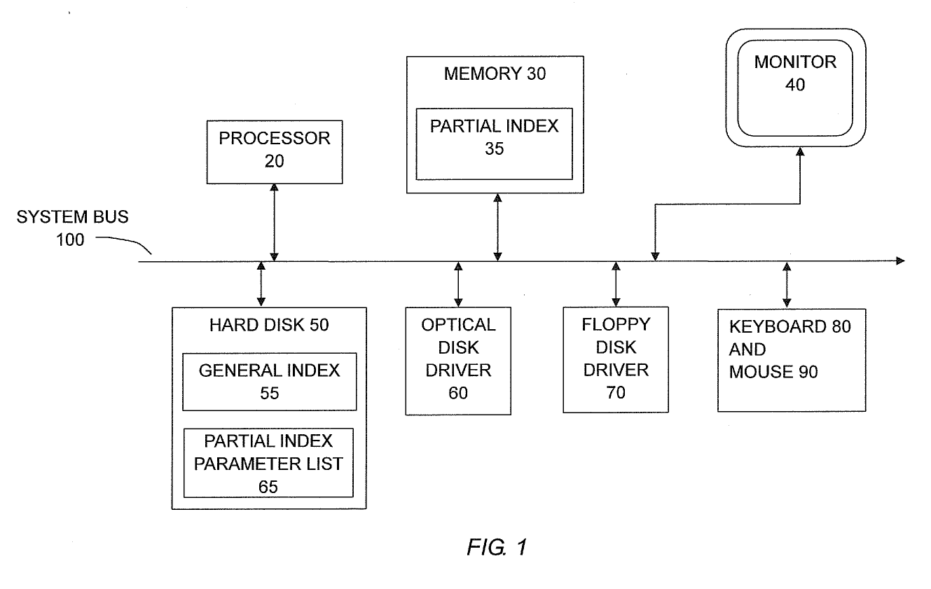

FIG. 1 is a structural drawing which shows the specific environment implementing this invention. It comprises system bus 100, processor 20, internal memory 30, display 40, hard disk 50, optical disk driver 60, floppy disk driver 70, keyboard 80 and mouse 90. Partial index 35 is stored in memory 30, and general index 55 generated by system is stored in hard disk 50. Partial index parameter list 65 is stored in hard disk 50. In the partial index parameter list there are some essential parameters stored for generation of partial index. This environment can be understood as a PC system or workstation. The environment herein is only a specific environment implementing the present invention. The implementation of the present invention is not confined to this configuration. For example, this system can also connect a printer. This structural drawing only shows the parts necessarily emphasized, without content of general knowledge. For example, operating system generally is stored on the hard disk, which is fetched to memory for running during running of computer, however no operating system drawn in hard disk 50 herein, because it is general knowledge for one skilled in the computer art. In addition the code of the system implementing the invention is also stored on hard disk, and which will be fetched into memory when running FIG. 1 shows partial index 35 is stored in memory 30, emphasizing partial index 35 is generated in memory. General index 55 is on hard disk 50, emphasizing general index 55 is finally formed and stored on hard disk 50. Without doubt, any data or code to be used will be fetched into memory first, this is general knowledge for one skilled in the computer art, and therefore this schematic has not drawn up correlated processes. In the implementation of the present invention, the set of documents is stored on the hard disk. The set of documents can also be stored on other computer-readable medium such as optical disk etc. The operating environment as shown in FIG. 1 can also be linked to a network. The set of documents can also be stored in the server of the network.

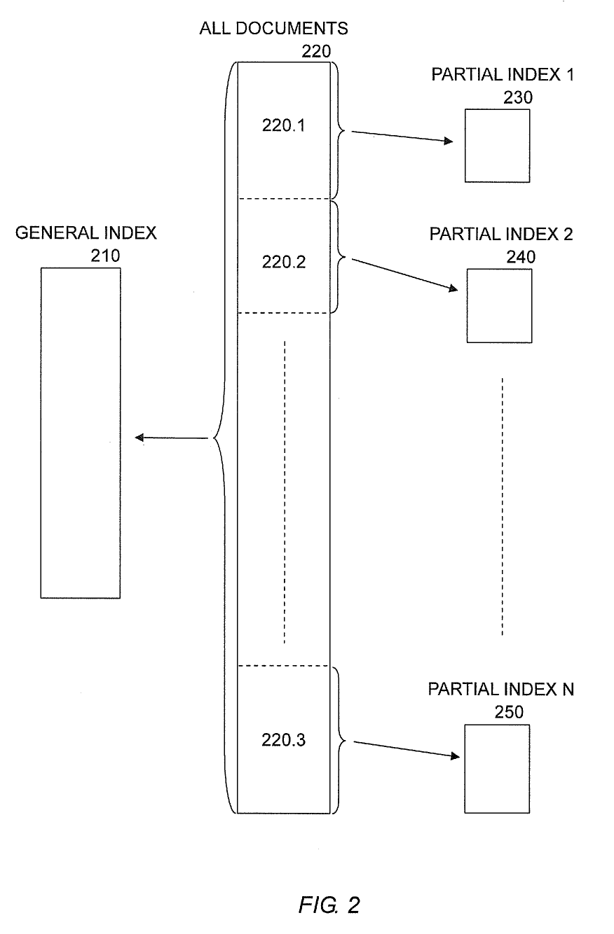

FIG. 2 is a schematic diagram showing the relations between general index, document (or passage) and partial index. In the diagram, 210 for general index, 220 for document (or passage), 230, 240 and 250 for partial indexes, 220.1, 220.2 and 220.3 are for three blocks. General index is the index formed by all documents, and therefore general index 210 corresponds to all documents 220. Partial index is the index formed by partial passages, which corresponds to partial passages, namely, partial index corresponds to block. In FIG. 2, 230 corresponds to 220.1, 240 corresponds to 220.2 and 250 corresponds to 220.3, namely, partial index 230 is generated by the passages in block 220.1, partial index 240 is generated by the passages in block 220.2, partial index 250 is generated by the passages in block 220.3.

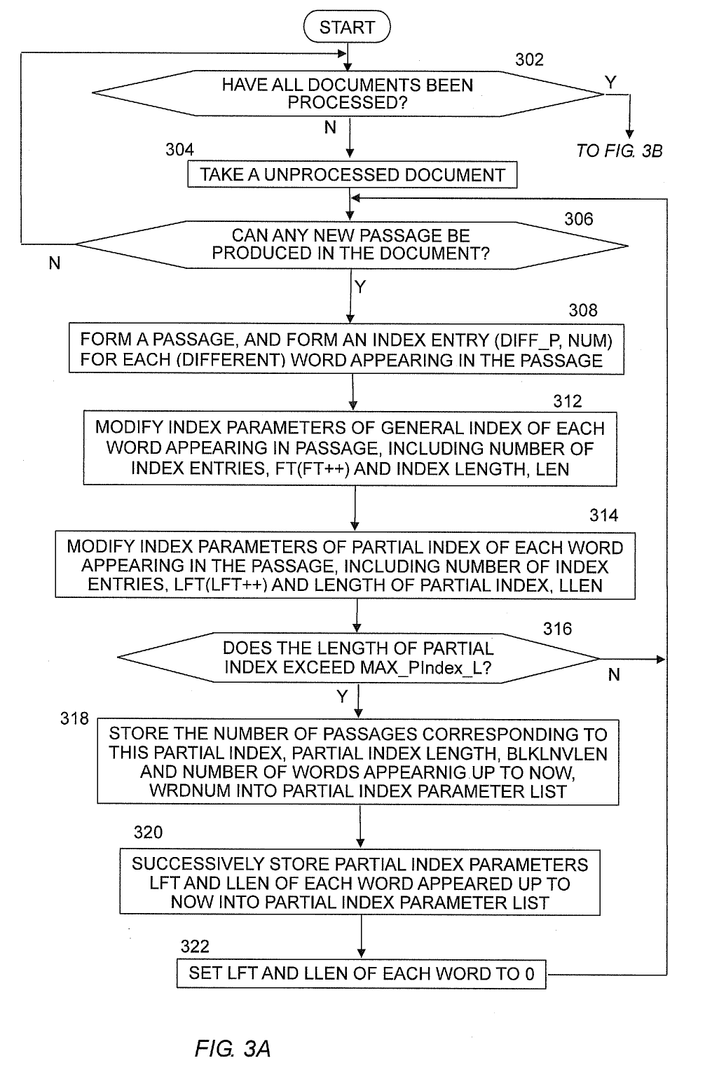

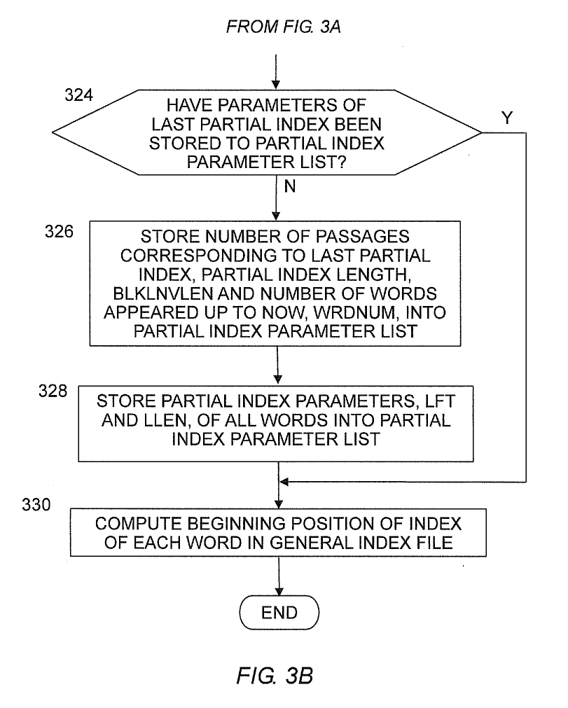

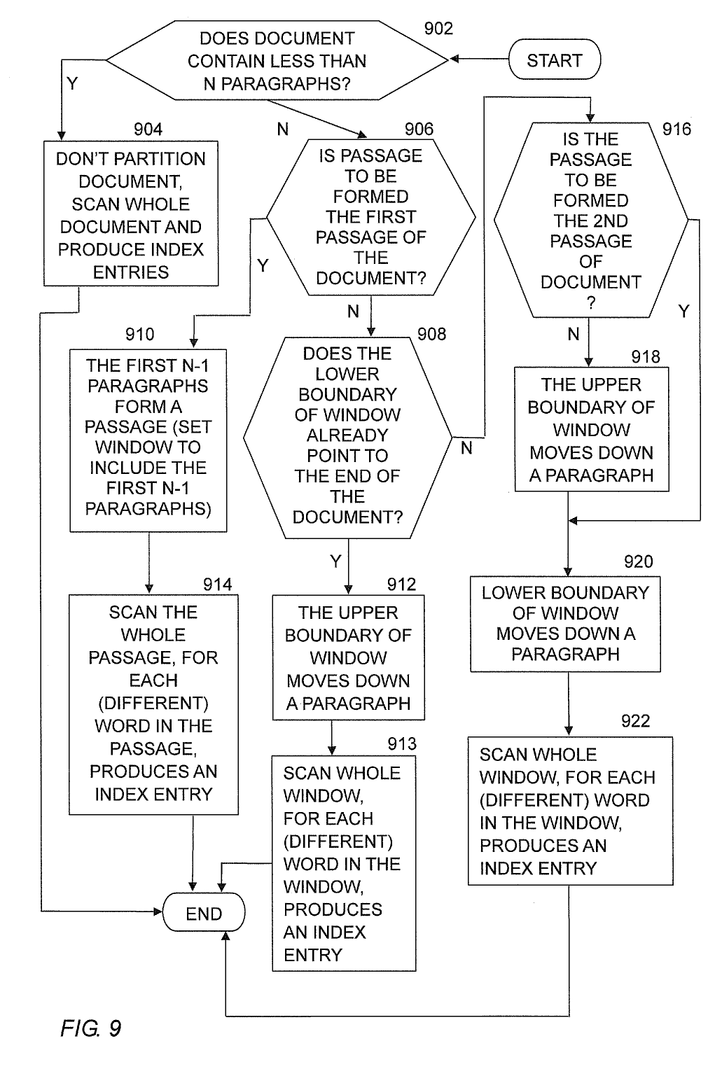

FIG. 3A and FIG. 3B together are the flow diagrams of the first time scan. Box 302 decides whether there is document to be processed, if all documents have been processed, the flow goes to box 324 (to FIG. 3B). If there is document to be processed, one unprocessed document is taken out from the set of documents (304). The document is analyzed to see whether the passages of document have been processed (306), i.e., whether new passages can be generated in terms of the passage formation method of the present invention, if all are processed (i.e., this document cannot have new passage formed any more), the flow goes to box 302. If there is still passages not processed (i.e., this document can still have new passages formed), a passage is then formed and each different word appeared in the passage forms an index entry (diff_p, num)(308), for detailed implementation of box 308, see FIG. 9. diff_p is the difference between this passage's number and a previous passage's number, num is the occurrence number of word in this passage. For example, Assume the passage formed in step 308 is P and W is a word appearing in P, (diff_p, num) is W's index entry. Then diff_p is the difference between P and the number of a previous passage in which W appeared. If W occurs for the first time, then diff_p is P. num is the occurrence number of W in P.

In step 312, the system adds 1 to the index entry number ft of each word present in the passage respectively, the length of each word index is modified to the sum of original length and the length of new index entry of the word. The system of this invention uses GAMMA encoding method to encode two quantities of index entries, therefore index length is the sum of original length and the length of newly generated index entry after GAMMA encoded. For GAMMA encoding method, refer to Ian H. Witten et al., “Managing Gigabytes: compressing and indexing documents and images (second edition)”, Morgan Kaufmann, 1999, pp. 116-129. ft and len correspond to a word, namely, a word correspond to a ft and a len, ft and len are not the total index entry number and length of all words. Box 312 is to process general index parameters. Box 314 in the underside is to process partial index parameters. In step 314, the number of partial index entries of each word appearing in the passage, lft, adds 1, and the partial index length of each word appearing in the passage, llen, is also modified in the same way as that in the general index length, as shown in the upside. Partial index entry number lft is the number of passages in a block where a certain word appears. lft and llen also correspond to a word, namely, a word correspond to a lft and a llen. Box 316 decides whether the length of partial index (summation of llen of all words appeared up to now) exceeds a preset length Max_PIndex_L, if not, the flow goes to box 306. If the length of partial index exceeds Max_PIndex_L, box 318 stores the corresponding parameters into partial index parameter list. Parameters stored include the number of passages forming this partial index, lpsg_num, length of partial index BlkInvLen, and the number of (different) words appeared up to now, WrdNum.

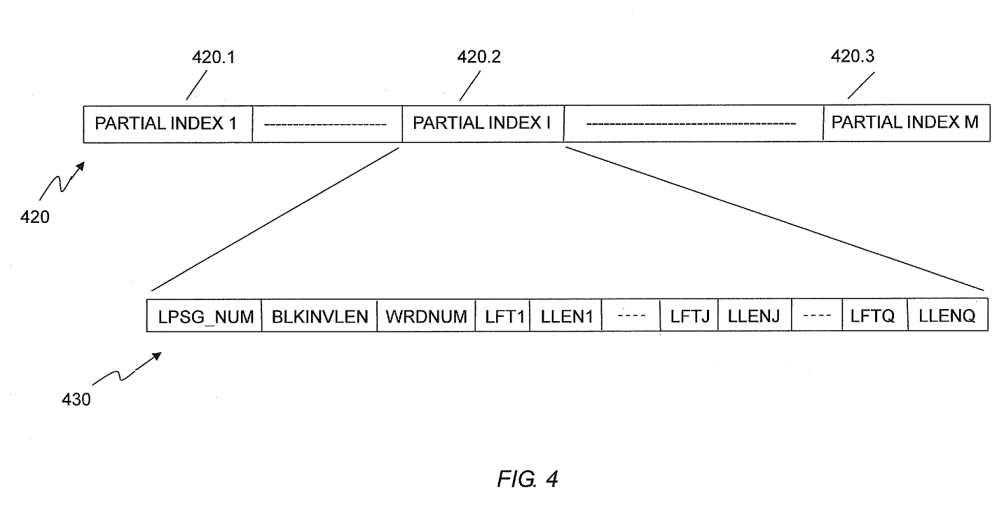

Additionally, the number of index entries in this partial index of all words appeared up to now, lft, and partial index length llen shall be successively put into partial index parameter list (box 320). Note that herein all words are the words appeared up to now beginning from the first (No. 1) passage, are not only the words appearing in the passages forming this partial index. If a word does not appear in the passages forming this partial index, but appears in the previous ones, its lft and llen in the partial index are both 0, i.e., lft and llen of the item corresponding to this word in partial index parameter list is 0, parameters lft and llen of word are stored in partial index parameter list in precedence order of occurrence of word. Partial index parameter list is as shown in FIG. 4. After box 320 performed, the flow goes to box 322, lft and llen of all words are set to 0 such that the parameters of next partial index can be formed. Then the flow goes to box 306.

Box 324 identifies whether the parameters of the last partial index have been put into partial index parameter list, setup of this step is the existing of following two cases. The first case is, see box 316, after the last passage (i.e., the last passage of last document) is processed by the system, and if the length of partial index formed just exceeds Max_PIndex_L, then the parameters of the partial index will be put into partial index parameter list. Note at this moment the passage is the last one of last document, that is to say, after processing this one, all documents have been processed, therefore, the procedure goes to box 302 (316→318→320→322→306→302) and at this moment the parameters of last partial index have been put into the partial index parameter list. The second case is that when processing the last passage, if the length of partial index (which is the last one) does not exceed Max_PIndex_L, then go to box 306, and the index parameters of this partial index are not put into partial index parameter list. Box 306 decides whether there is passage to be processed, because this is the last one, there are no more passages, the flow goes to box 302; since all documents have been processed, again the flow goes to box 324, here the parameters of the last partial index are not put into partial index parameter list, therefore, in such a case the parameters of this partial index shall be put into partial index parameter list. Box 326 stores the number of passages forming last partial index, length of partial index, BlkInvLen, and the number of words appeared up to now, WrdNum, into partial index parameter list. By now since all documents have been processed, consequently the number of words, WrdNum, is the number of all of the different words included in the document set. Box 328 successively stores the parameters lft and llen in the last partial index of all words into partial index parameter list. By this time all documents have been processed, and the total index length of each word has been determined, consequently the initial point of each word in general index can be determined (box 330). The philosophy is that the initial point of the index of word followed is the sum of index lengths of previous words (previous words are the words which occur in advance). In the implementation of the present invention, index length is expressed in bit, but not byte. So in general index, the initial point of index of each word is all multiple of 8, that is to say, the initial point of word index getting start from one byte, so in step 330, if the initial point of word index doesn't get start from a byte, the initial point will be adjusted to get start from an integral byte (a multiple of 8). After box 330 is executed, the first time scan ends.

FIG. 4 is a schematic diagram of partial index parameter list. The parameters of each partial index are successively stored into the list 420 is partial index parameter list. Parameter of partial index 1, 420.1, parameter of partial index i, 420.2, and parameter of the last partial index m, 420.3, are all stored in parameter list 420 successively. The detailed contents included in each partial index parameter item are as shown in 430, including the number of passages forming partial index, lpsg_num, length of partial index, BlkInvLen, and the number of words appeared up to now, WrdNum, followed by the number of index entries and index length in partial index of each word appeared to now, which respectively are lft1, llen1, . . . , lftj, llenj, . . . , lftq, llenq. To facilitate the description, we refer to the block forming partial index i as block i, then in 430, lpsg_num is the number of passages contained in block i. BlkInvLen is the length of partial index i. WrdNum is the number of all of (different) words appearing until block i (including block i). lft1, llen1 to lftq, llenq is the number of index entries and index length in partial index i of each (different) word appearing until block i (including block i). The maximal subscript of lft and llen is q, representing that q words have appeared until block i (including block i). The number of index entries in partial index i of the word firstly occurring is lft1, the index length of the word is llen1, . . . , the number of index entries in partial index i of the word jthly occurring is lftj, the index length of the word is llenj, . . . , the number of index entries in partial index i of the word qthly occurring is lftq, the index length of the word is llenq. If a word doesn't occur in block i (it occurs in previous blocks), then the number of index entries, lft and index length llen in partial index i of the word are all 0.

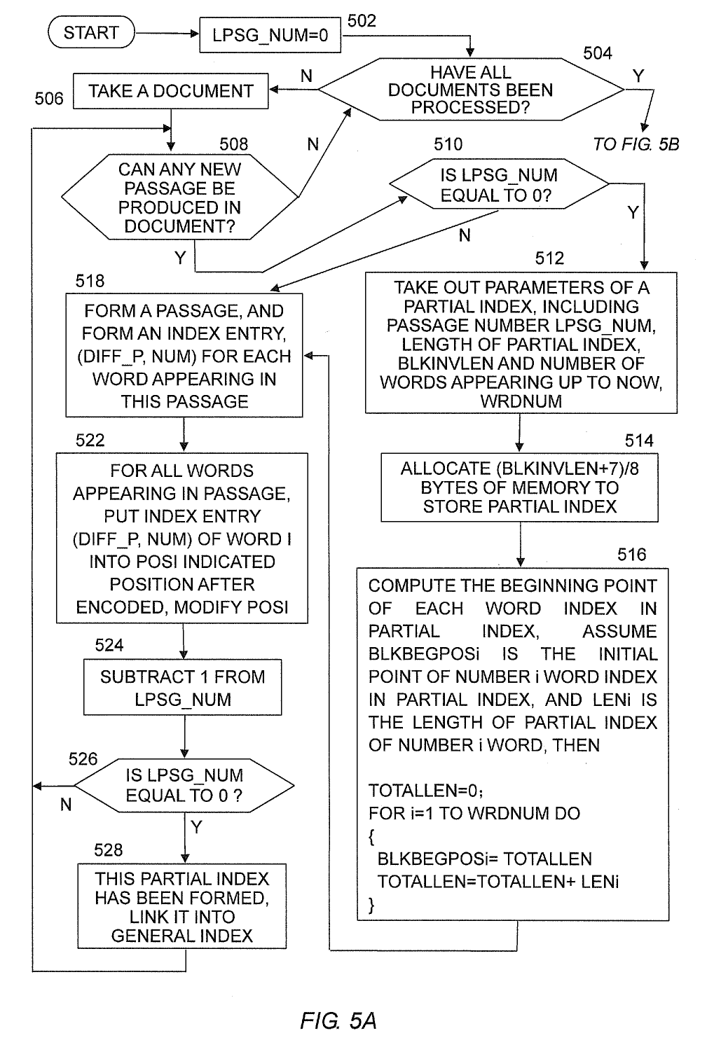

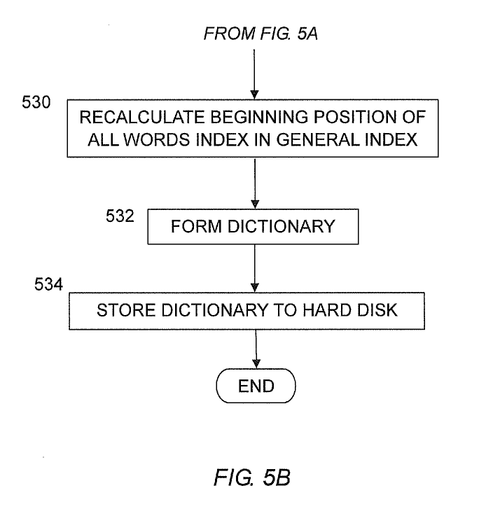

FIG. 5A and FIG. 5B together are the flow diagrams of the second time scan. The second time scan generates indexes on the basis of the first time scan. The first time scan records the partial index length of each word in each block, and records the length of each word's index in general index and determines the initial point of each word's index in general index, and consequently the second time scan can practically generate an index.

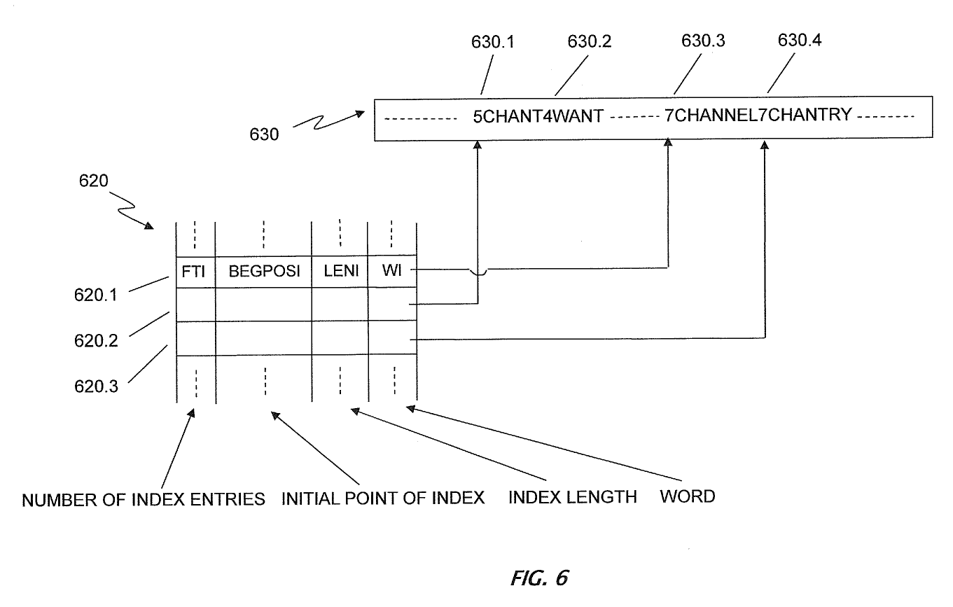

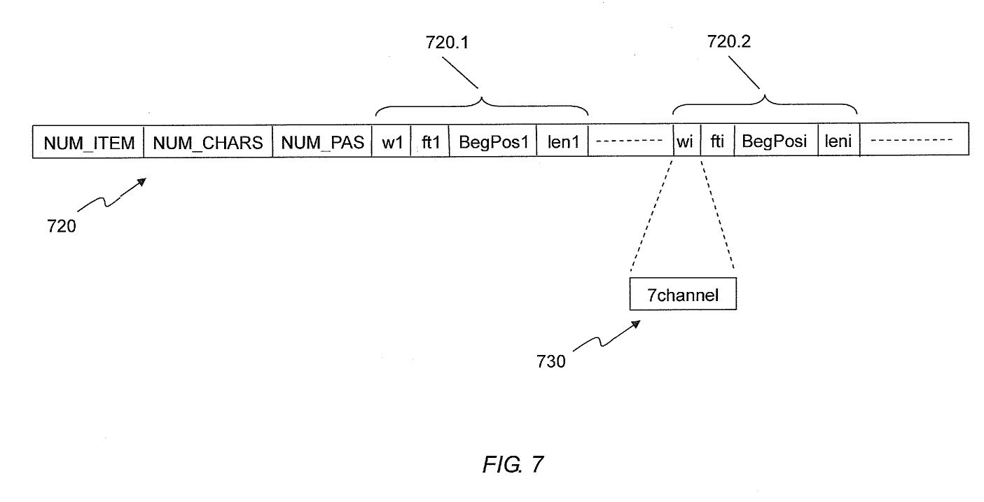

The specific procedure is as below: box 502 sets lpsg_num to 0, lpsg_num represents the number of remaining passages which are not processed in a block, and serves as a mark used for deciding whether parameters of the next partial index are to be taken out. Equaling 0 of lpsg_num represents all passages corresponding to a partial index, have already been processed. Parameters of the next partial index need to be taken out for further processing. When the second time scan begins, lpsg_num is set to 0, and then box 504 identifies whether the documents in a document set have been fully processed. If so, the flow goes to box 530 (to FIG. 5B). If not, an unprocessed document is taken out (box 506). Box 508 decides whether there is any unprocessed passage. Namely, box 508 analyzes to see whether new passages can be generated in terms of the passage formation method of the present invention, if all passages have already been processed (i.e., this document cannot form any new passages). The flow goes to box 504; if there is any passage remaining unprocessed, the flow goes to box 510. Box 510 identifies whether lpsg_num equals 0 or not, if not, the flow proceeds to box 518; if yes, box 512 is executed. Box 512 takes out the parameters of a partial index from partial index parameter list, including passage number lpsg_num forming the partial index, partial index length BlkInvLen and number of words appeared up to now, WrdNum. After the partial index parameters are taken out, box 514 allocates (BlkInvLen+7)/8 bytes in memory in order to store partial indexes. BlkInvLen is the bit number of partial index but not the byte number; therefore it should be converted into a byte number (divided by 8). After that, box 516 finds the initial point for storing partial index of each word such that when produced, the indexes can be stored to respective positions. In a partial index, the initial point of index of a word is the sum of the index lengths of all previous words. In a partial index, it is not required for initial point of word index to be at an integral byte. In box 516, TotalLen is the sum of index lengths of the first i words in a partial index. The procedure goes over to box 518. Box 518 forms a passage and generates an index entry (diff_p, num) for each different word in passage. diff_p is the difference between this passage's number and the number of previous passages in which this word appears, num is the occurrence number of this word in this passage. For example, Assume W is a word appearing in current passage, (diff_p, num) is W's index entry. Then diff_p is the difference between the number of current passage and the number of a previous passage in which W appears. If W occurs for the first time, then diff_p is the number of current passage. num is the occurrence number of W in current passage. For a detailed implementation of box 518, refer to FIG. 9. Box 522 encodes the index entry (diff_p, num) of word i (word i is the word appearing ithly) and then store it to position specified by Posi, encoding the index entry, (diff_p, num) means to encode diff_p and num using GAMMA encoding method respectively. Posi is modified (Posi=Posi+length of diff_p's coding+length of num's coding). At the beginning, Posi points to the initial point BlkBegPosi of the index of Number i word, and with the storing of index entries, Posi gradually moves backwards. Upon the completion of processing a passage, lpsg_num minus 1 (box 524). Box 526 identifies whether lpsg_num equals to 0 or not, if not, the flow goes to box 508; if yes, i.e., lpsg_num equals to 0, it means that passages corresponding to this partial index have already been processed (passages corresponding to a partial index refer to the passages forming the partial index), and partial index have been generated, box 528 links the partial index into general index, the flow goes to box 508 for further processing. Boxes 504-528 are repeated to form partial index time and again and then link partial index into general index, general index then forms when all documents are processed. Box 530 recalculates the initial point of index of each word in general index. The first time scan have computed the initial point of index of each word in general index (see FIG. 3 step 330), but in step 528, whenever a partial index of a word is linked into general index, the initial position of the word's index is modified to the sum of current position and the length of the partial index linked in order to indicate the position into which the next partial index of the word is linked, so it is needed to recalculate the beginning position of index of each word in general index in step 530. Assume in general index, the beginning position of index of the ith word is INIPOSi, the length of index is GLENi, after all partial indexes are linked into general index, the position information of index of the ith word points to INIPOSi+GLENi. Box 530 recalculates the initial points of indexes of words. The specific method is to modify the initial point of index of the ith word to ((INIPOS₍ᵢ₋₁₎+GLEN₍ᵢ₋ₗ₎+7)<<3)>>3, wherein, i>1, INIPOS₁=0, <<3 represent shifting 3 bits to left, >>3 represent shifting 3 bits to right, namely, the initial point of index of a word is recalculated to current position of index of its previous word, if the position doesn't get start from a byte, the initial point will be adjusted to get start from an integral byte. Box 532 is to form a dictionary, of which the structure is as shown in FIG. 6, including word, the number of indexed entries of each word, initial point of word index (word index's position in general index file), and the length of word index. Box 534 stores the dictionary into hard disk. The format of the dictionary stored on hard disk is as shown FIG. 7. The dictionary is used in search phase, and at the start of search phase it is taken into memory.

FIG. 6 is a structural schematic diagram of dictionary in memory. 620 is an aggregation of dictionary items, each item of dictionary consists of word, index length, initial point of index and number of index entries. 620.1, 620.2 and 620.3 are three items in dictionary, among which 620.1 comprises Number i word, wi; number of index entries of word wi, fti; word wi's index length, leni; and initial point of word wi's index, BegPosi. Here the word field, wi, is an pointer pointing to the position storing the word. In FIG. 6, wi corresponds to word 630.3 ‘channel’. The storage format of words in the dictionary is shown in 630 where the first character of each word is the length of that word (i.e., the number of characters of word), followed by the word itself. All words are stored successively. In 630, words are stored in precedence order of their occurrence. The words occurring ahead are stored in advance. There are 4 words (chant, want, channel, and chantry) in 630, the numeric character ahead of each word is the length of this word, where channel, chant and chantry are words corresponding to items 620.1, 620.2 and 620.3, and their storage positions are respectively 630.3, 630.1 and 630.4. The storage position of word, want, is 630.2, which occurs earlier than word, channel 630.3. Word field of item 620.1 points to 630.3, word field of item 620.2 points to 630.1 and word field of item 620.3 points to 630.4. The dictionary items are sequenced according to the words included in them. In search phase, Binary search is used to consult the dictionary.

FIG. 7 is a structural schematic diagram of dictionary stored in hard disk. 720 is entire dictionary in hard disk. In it, NUM_ITEM is the number of items in dictionary. In the dictionary, a word has an item, so NUM_ITEM is also the number of words in the dictionary. NUM_CHARS is total byte number of all words in the dictionary. The total byte number includes the numeric character ahead of each word. For example, assume totally there are three words in the dictionary, they are 5chant, 4want and 7channel respectively, then NUM_CHARS is 19 (the byte number of all words plus that of the numeric character ahead of each word). In the implementation of the present invention, the numeric character ahead of word occupies a byte, so the maximum length of a word is 255. A character string more than 255 characters will be decomposed into strings less than or equal to 255 characters. Setting the maximum length of words (or string) to 255 is only a specific implementation of this invention, shouldn't be understood as a restriction. NUM_PAS is total number of passages. 720.1, 720.2 are two items of dictionary. Each item consists of word, number of index entries, initial point of index and index length. In dictionary stored in hard disk, words are stored according to their sequence. 730 is an example of a word stored in hard disk, therein, there is a number ahead of a word to express the length of the word.

The second time scan is executed on the same set of documents as the first time scan.

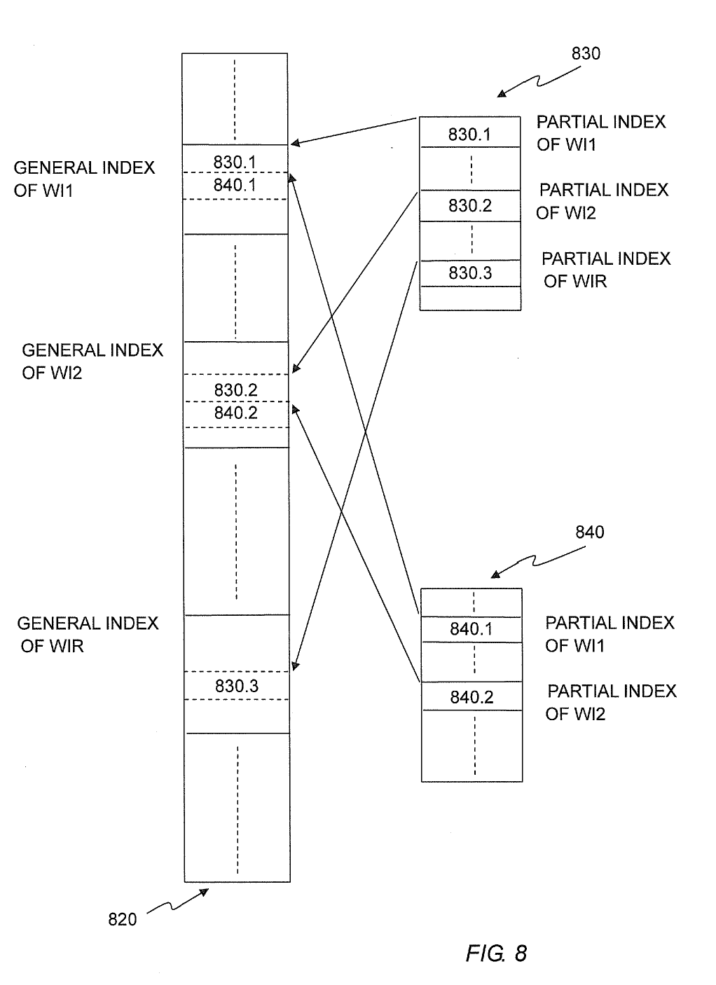

FIG. 8 is a schematic diagram showing the link of partial index into general index, in which 820 is general index, and 830 and 840 are two adjacent partial indexes respectively, namely, after 830 is formed, next partial index formed is 840. 830.1, 830.2 and 830.3 are partial indexes respectively for words Wi1, Wi2 and Wir which are in partial index 830; 840.1 and 840.2 are partial indexes respectively for words Wi1 and Wi2 which are in partial index 840. In partial index 840 there is no index for word Wir (i.e., word Wir does not appear in the passages producing partial index 840), 830.1, 830.2 and 830.3 in partial index 830 are put into general index 820, and then 840.1 and 840.2 in partial index 840 are linked into the rear of 830.1 and 830.2.

FIG. 9 is a flow diagram for forming a passage and indexes of words in the passage. Box 902 identifies whether a document contains less than N paragraphs, if yes, then the document is not partitioned (box 904), the whole document is a passage. At this time, the whole document is scanned. Each (different) word in the document produces an index entry. After box 904 performed, the process ends that forms passage and indexes of words in the passage this time. If the document contains N or more than N paragraphs, the system identifies whether the passage to be formed is the first passage of the document (box 906). If yes, the first passage of a document contains N−1 paragraphs, so the first N−1 paragraphs are taken to form a passage (a window is set to contain N−1 paragraphs) (box 910). The whole passage is scanned (namely the first N−1 paragraphs are scanned). Each (different) word in the passage produces an index entry (box 914). After box 914 performed, the process ends that forms passage and indexes of words in the passage this time.

In step 906, if the passage to be formed isn't the first passage of the document, box 908 identifies whether lower boundary of window has already pointed to the end of the document. If yes, the passage to be formed is the last passage of the document, then box 912 is executed. The last passage of a document contains N−1 paragraphs, so the upper boundary of window moves down a paragraph (912). Then in step 913, whole window is scanned (a window corresponds to a passage). Each (different) word in the window produces an index entry. After box 913 performed, the process ends that forms passage and indexes of words in the passage this time. If the condition of box 908 is not satisfied, namely the lower boundary of window does not point to the end of the document, then box 916 identifies whether the passage to be formed is the second passage of the document. If not, the passage to be formed is “intermediate” passage. Window moves down a paragraph. Namely the upper boundary of window moves down a paragraph (box 918), again the lower boundary of window moves down a paragraph (box 920), then whole window is scanned (a window corresponds to a passage), each (different) word in the window produces an index entry (922). If the condition of box 916 is satisfied, namely the passage to be formed is the 2nd passage of the document. The first passage only contains N−1 paragraphs, so the flow directly goes to box 920. In step 920, the lower boundary of window moves down a paragraph to make the passage contain N paragraphs, then box 922 is executed. After box 922 performed, the process ends that forms passage and indexes of words in the passage this time. In the present invention, the preferred value of N is from 2 to 30, and more preferably the value of N is 6.

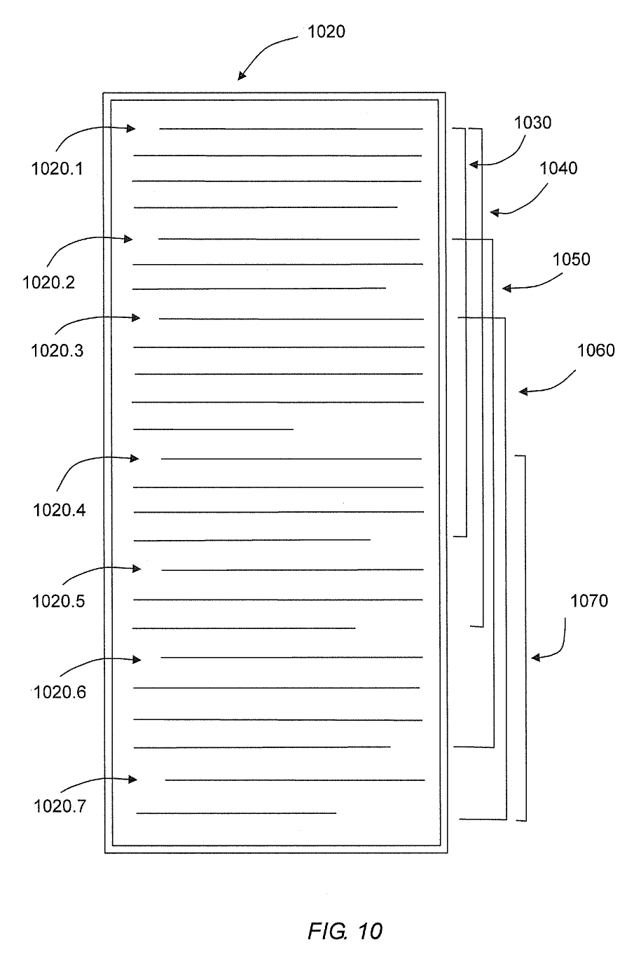

FIG. 10 is a schematic diagram showing the manner of forming passages. In the diagram, the value of N is set to 5. 1020 is a document. Document 1020 contains 7 paragraphs. They are respectively 1020.1, 1020.2, 1020.3, 1020.4, 1020.5, 1020.6 and 1020.7. In the diagram, indent indicates the beginning of a paragraph. Five passages are formed for document 1020. The five passages are respectively 1030, 1040, 1050, 1060 and 1070. 1030 is the first passage of the document. It is constituted of 1020.1-1020.4 four paragraphs. 1040 is the second passage of the document. It is constituted of 1020.1-1020.5 five paragraphs. 1050 is constitute of 1020.2-1020.6 five paragraphs. 1060 is constituted of 1020.3-1020.7 five paragraphs. 1070 is the last passage of the document. It is constituted of 1020.4-1020.7 four paragraphs. For passage (or window) 1050, the beginning of paragraph 1020.2 is its upper boundary, the end of paragraph 1020.6 is its lower boundary.

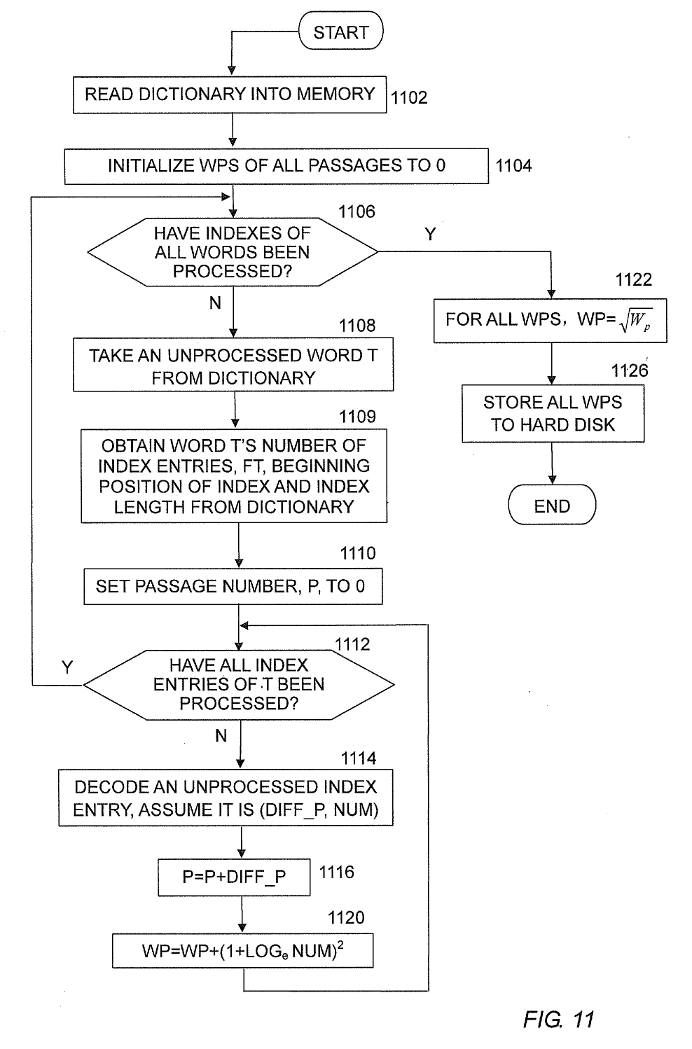

After the formation of general index, the Wp are computed. FIG. 11 is the flow diagram computing Wp. For formula computing Wp, see formula (1.2). Firstly, dictionary is read into memory (box 1102), and then all Wps are initialized to 0 (box 1104). Box 1106 identifies whether indexes of all word in dictionary have been processed, if yes, the flow goes to box 1122; if not, box 1108 takes a word T from the dictionary which remains unprocessed and box 1109 gets the number of index entry, ft, initial point of index, and index length of word T from dictionary. Box 1110 sets passage number p to 0. Box 1112 identifies whether index entries of T have been fully processed, if yes, the flow goes to box 1106; if not, box 1114 is executed, and box 1114 decodes an T's index entry (diff_p,num) remaining unprocessed, herein decoding directly is made on the indexing file, not necessarily taking the whole index of T into memory. diff_p is the difference between the passage number of this index entry and that of the last index entry, therefore the passage number of this index entry p=p+diff_p (box 1116), num is the occurrence times of word T in Number p passage, therefore Wp=Wp+(1+logₑ num)² (box 1120). Then the flow goes to box 1112. In step 1106, when its condition is satisfied, box 1122 is executed. For all passages, box 1122 computes Wp=\sqrt{Wₚ}. Box 1126 stores Wps of all passages into hard disk. After step 1126 is executed, the process ends that computes Wp.

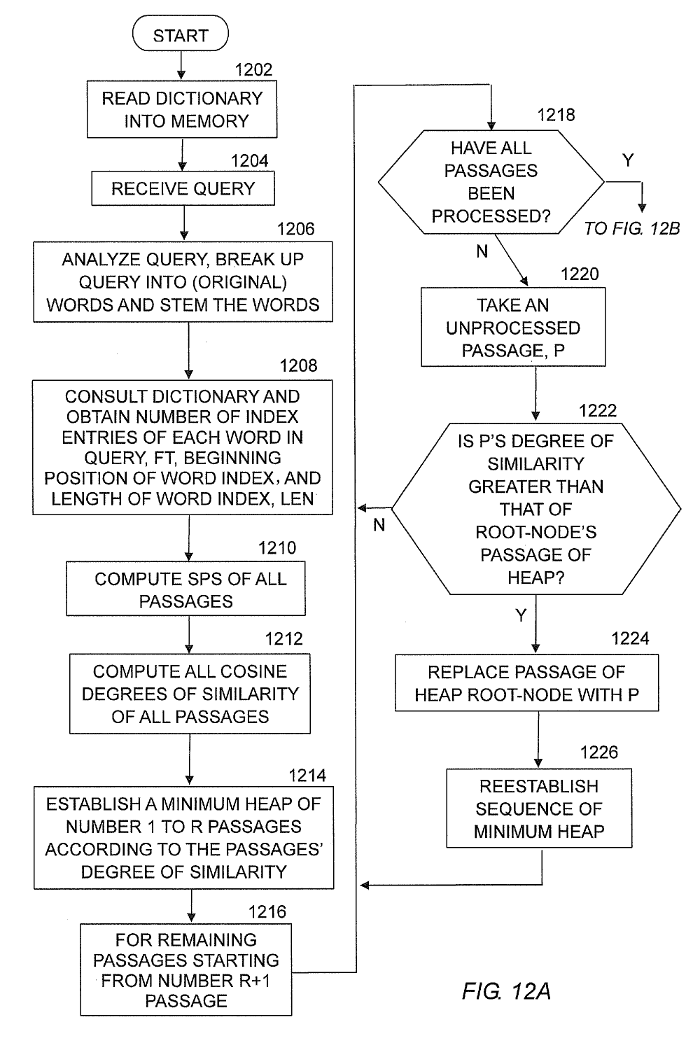

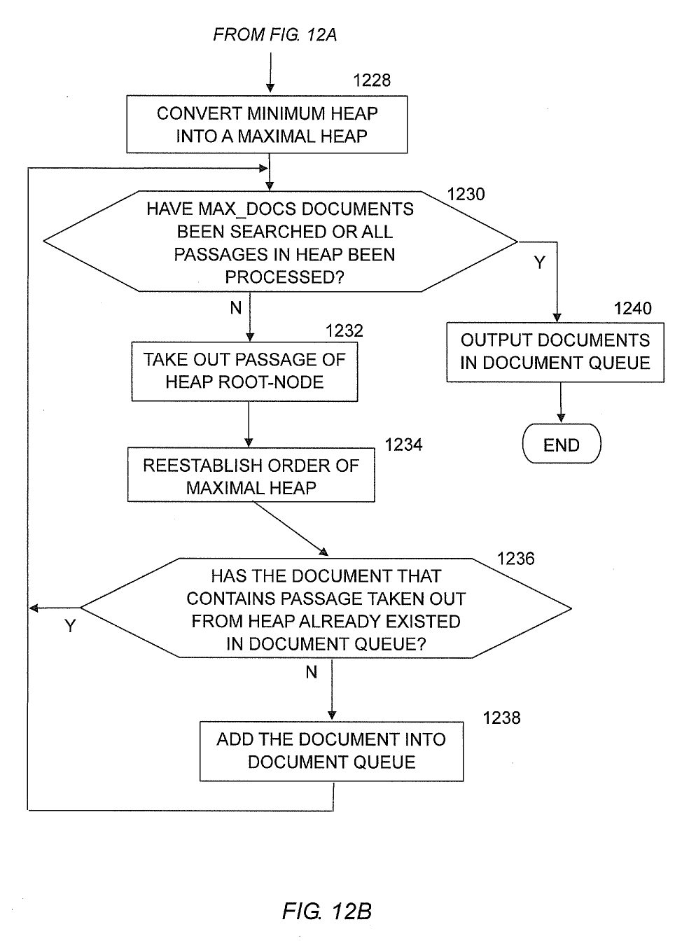

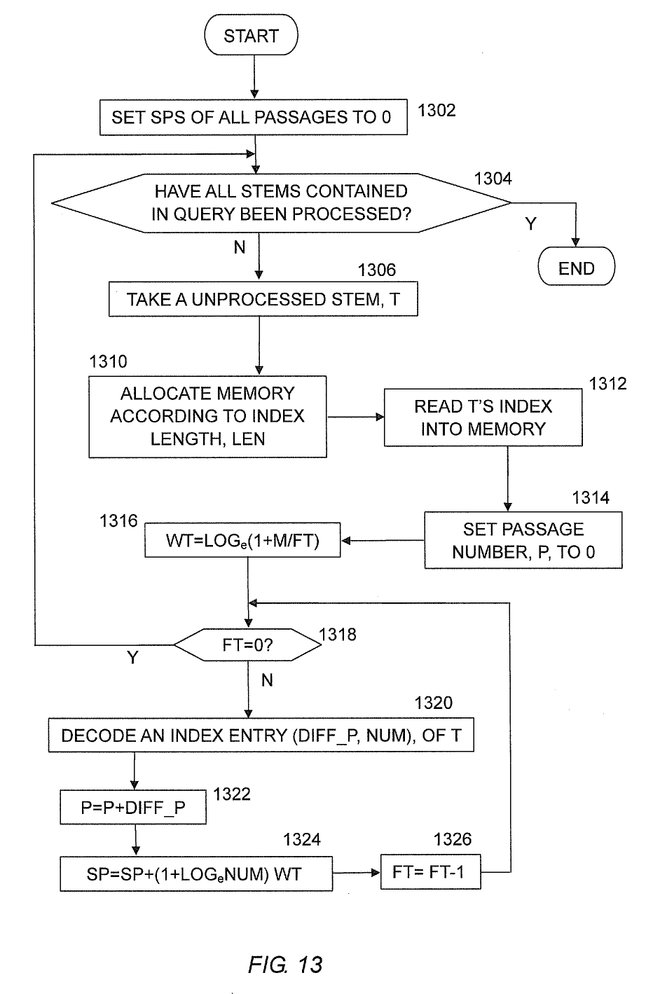

Finally, the system will search relevant documents in terms of query. FIG. 12A and FIG. 12B together are flow diagrams of search phase. First of all, box 1202 puts the dictionary into memory, then box 1204 receives query, Box 1206 analyzes the query, breaks up the query into (original) words and conducts the stemming process, and next box 1208 consults the dictionary to get the index information of each word in the query, including the initial position of word index in general index, length of word index, Len and the number of word index entries, ft. The procedure continues to execute box 1210, box 1210 computes Sps of all passages, for the determining method of Sp, refer to FIG. 13. And then box 1212 computes the cosine degree of similarity of all passages, i.e., read each Wp sequentially from hard disk one by one, every time when reading a Wp, Sp/Wp is computed to yield the cosine degree of similarity of a passage and query. The following boxes 1214-1226 are to determine the passages of which the cosine values are at top r. The program uses heap to implement this functionality. Box 1214 establishes the minimum heap of r passages of Number 1 to Number r passages based on the cosine degree of similarity of the passages (the minimum heap features that the value of the root-node is less than that of its two sons, so the value of the root-node in minimum heap is minimal). Where r is an artificially set value, which refers to how many passages will be finally reserved for ranking, i.e., in the end only r passages, not all passages, will be ranked, therefore, the preset r value shall be such that it can ensure a certain number of documents will be searched. The final output of this system is not passages, but the documents. The ranking of documents previously referred to are determined by the rank position of the passage the document includes with the highest cosine value. Possibly there are a number of passages in a document ranked at the top, if r value is not great enough, a certain number of documents may unlikely be searched. For an extreme example, if we desire to search documents in a total number of r, and for this case we only rank r passages, and in which 2 of the passages pertains to one and the same document, in such a case we can only get documents in a number of r−1 at most due to the fact that the rank of a document is only determined by the passage with topmost rank. Therefore, the r-value should be greater than the number of documents desired. In the specific implementation of the invention, for cases that the desired retrieval documents not more than 1,000 in number, we set r to 30,000. Box 1216 starts from Number r+1 passage to compare the degree of similarity of each passage with that of heap root-node, if the cosine degree of similarity of a passage is greater than the value of root-node, this passage shall be ranked in top r. Therefore, the passage of heap root-node is deleted, and the degree of similarity of this passage is put into root-node, the cosine degree of similarity newly put into heap root-node is not necessarily the least one within the r passages in the heap. Accordingly, the sequence of heap is destructed, and a heap sequence needs to be reestablished, this process is repeatedly executed for the remaining passages, finally the passages in the heap are r passages with top cosine degrees of similarity. Box 1218 identifies whether all passages have been fully processed, if yes, the flow goes to box 1228 (to FIG. 12B); if there are any passages remaining unprocessed, box 1220 get one of them and assume the passage is p, then box 1222 identifies whether the cosine degree of similarity of p is greater than that of the minimum heap root-node. If not, the flow goes to box 1218; if yes, the flow goes to box 1224. Box 1224 replaces the passage of root-node with p, the joining of p may likely damage the sequence of the minimum heap, and therefore box 1226 regenerates the sequence of minimum heap. Then the flow goes to box 1218. The following boxes 1228-1238 (as shown in FIG. 12B) are passages ranking from high to low in terms of cosine values, along with the ranking of documents. This system also implements this functionality with heap in the following procedure: box 1228 processes the previous minimum heap to convert it to a maximum one (maximum heap refers to the heap of which the root-node value is more than its two sons' values), the root-node value of the maximum heap is the maximum value in the heap, successive exporting of passages of root-node corresponds to top-down ranking of passages in terms of cosine values. Box 1230 identifies whether a certain number of documents (Max_Docs) have been searched or whether all of passages in heap have been processed (i.e. heap has emptied), Max_Docs is the number of documents desired to be searched (namely, the above-mentioned number of documents returned to users), for example, if 1000 documents are desired to be searched, then Max_Docs equals 1000. Max_Docs is set in search instruction. If the conditions of box 1230 are satisfied, the documents searched are outputted (box 1240), and the searching process ends. Otherwise, the passage of heap root-node is taken out from heap (box 1232) and then maximum heap sequence is re-established (box 1234). Every time when a passage is taken out, it is checked to see if the document containing this passage has been ranked (i.e., whether the document has been put into the document queue) (box 1236), if not yet, the document is added to the document queue (box 1238), and then the flow goes to box 1230. If the passage-corresponding document has already been ranked (already in document queue), indicating that there has been other passages in this document have been selected previously, since document is ranked in terms of its passage with topmost cosine value. This document is not necessarily put into the document queue again. The flow goes directly to box 1230. Boxes 1230-1238 is repeated until Max_Docs documents are contained in the document queue, or all passages in the heap have been fully processed (i.e. heap has emptied). Finally the documents of the queue are outputted (box 1240). It is possible that there are no Max_Docs documents searched until the processing of passages in the heap is complete (i.e. heap has emptied). This indicates the r-value is insufficient, and should be increased.

FIG. 13 is the flow diagram for determination of Sp (for computation of Sp refer to Formula 1.4). Firstly box 1302 initializes Sps of all passages to 0, then box 1304 identifies whether words in query have been processed. If all the words have been processed, the flow goes to the end, if not, box 1306 takes an unprocessed word T from query. Following steps are executed according to T's index information gotten in step 1208 of FIG. 12, including initial point of index, index length, Len and index entry number, ft. Box 1310 allocates ((Len+7)<<3) bytes in memory. Box 1312 reads the index of T from hard disk into memory. Box 1314 initializes passage number p into 0. Box 1316 computes Wt, Wt=logₑ (1+M/ft), where M is the number of all passages. Box 1318 identifies whether there are still any index entries in the index of T remaining unprocessed, i.e., identifies whether ft=0. If ft equals to 0, indicating all of index entries of T have already been processed, then the flow goes to box 1304. If not, box 1320 decodes the index of T, yielding an index entry (Diff_p, num). Since Diff_p is the difference between passage numbers, the current passage's number p=p+diff_p (box 1322), Sp=Sp+(1+logₑ num)×Wt (box 1324), by this time an index entry of T has been processed, therefore ft=ft−1 (box 1326), the flow goes to box 1318.

The present invention mainly relates to a method forming passages. An information retrieval system is developed to show an application of the method and the efficiency of the method. But the method is not limited to the field of information retrieval. It can be applied to other natural language processing problems such as automatically question-answering etc.

The descriptions and diagrams presented herein should be understood as a specific implementation method of the present invention rather than a restricted area. The implementation of this invention is variable within the range of its concept. For example, although the ranked-query is used in this disclosure, a Boolean Query can also be adopted at the passage level, namely, if a Boolean expression of query isn't satisfied in the scope of a passage (N paragraphs), then the passage isn't regarded as one to be retrieved, only the passages are returned which match the Boolean expression of query in the scope of N paragraphs. Additionally, the system herein returns documents but can also be modified such that it returns corresponding passages.

An application of the present invention is to establish index for search engines. Certainly, the form of the index may need to be adapted to suit the function of search engines, for example, adding website into the index etc. The spirit of the present invention is: each N consecutive paragraphs form a passage. The preferred value of N is from 2 to 30, and more preferably the value of N is 6. Changes may be made in the specific implementation of the invention without departing from the principles and spirit of the invention, the scope of which is defined in the claims and their equivalents.

Another application of the present invention is digital library. A way of the application is as follows. Firstly, books are converted to computer-readable form, then the method of the invention is used to establish index to retrieve the books. The said retrieval herein can be retrieval content-based (don't retrieve books by title), namely, users give a query, then system search those books containing the words of query. Originally computer-readable books such as electronic books can be processed directly by index generation module to produce index. Originally computer-unreadable books can be converted into computer-readable form by recognizing with word recognition software etc. firstly and then rectifying the result of recognition by persons. Index generation module processes the books converted to produce index.

The applications introduced herein only illustrate with examples, they shouldn't be understood as a restriction. The present invention can be applied to other aspects. For example, the method of the invention's determining passages can be used to automatically abstracting etc.

The spirit of the present invention is that each N consecutive paragraphs form a passage. In the above-described implementation, the spirit is realized in index generation phase (index is produced based on each N paragraphs), namely, each N consecutive paragraphs form a passage, then each (different) word in passage form a index entry (diff_p, num), num is the number of words appearing in the passage (namely, N paragraphs). The spirit of the present invention doesn't restrict to being implemented only in index generation phase. The spirit of the invention can also be realized in search phase, the specific method is as follows. In index generation phase, index is produced based on each paragraph, namely, each (different) word in a paragraph forms an index entry (diff_p, num), wherein, diff_p indicates a paragraph, num is the occurrence number of a word in the paragraph. In search phase, assume W is a word. Adding word numbers (the second component) of index entries, the difference of the first component of which is within N, can obtain the word number of W in a passage (namely, N paragraphs). This is equal to forming a passage with each N consecutive paragraphs. Then the sum is used as fp,t of formula (1.1)-(1.4) to compute cosine degree of similarity.

What is claimed is:

1. A processor-implemented method for analyzing a document including paragraphs and determining passages included in said document, the method comprising:
processing the document to group the paragraphs into at least one passage;
wherein the at least one passage is a single passage when the document contains less than N paragraphs, wherein N is an integer greater than 1;
wherein each N consecutive paragraphs in said document are merged to form the at least one passage when the document contains at least N paragraphs, such that if the document contains more than N paragraphs the document will include respective passages having at least one identical paragraph.

2. The method of claim 1, wherein
if said document contains at least N paragraphs, merging the first N−1 consecutive paragraphs to form a first passage of said document, and merging the last N−1 consecutive paragraphs to form a last passage of said document,
wherein when the document contains at least N paragraphs, at least three passages are formed in the document, and the document will include respective passages having at least one identical paragraph.

3. The method of claim 1, wherein N is from 2 to 30.

4. The method of claim 2, wherein N is from 2 to 30.

5. The method of claim 3, wherein N is 6.

6. The method of claim 4, wherein N is 6.

7. A processor-implemented method for forming indexes by analyzing a document including paragraphs, the method comprising:
processing the document to group the paragraphs into at least one passage;
creating at least one index, each index including a passage-identifier and a word-number identifier;
wherein the at least one passage is a single passage when the document contains less than N paragraphs, wherein N is an integer greater than 1;
wherein each N consecutive paragraphs in said document are merged to form the at least on passage when the document contains at least N paragraphs, such that if the document contains more than N paragraphs the document will include respective passages having at least one identical paragraph.

8. The method of claim 7, wherein if the document contains at least N paragraphs, merging the first N−1 consecutive paragraphs of said document to form a first passage of said document, relating said first passage with words in the first passage to form a first index of the at least one index, merging the last N−1 paragraphs of said document to form a last passage of said document, and relating said last passage with words in the last passage to form a last index of the at least one index.

9. The method of claim 7, wherein N is from 2 to 30.

10. The method of claim 8, wherein N is from 2 to 30.

11. The method of claim 9, wherein N is 6.

12. The method of claim 10, wherein N is 6.

13. Indexes on a computer-readable medium, said indexes being formed by a process of analyzing a document including paragraphs, said process comprising:
processing the document to group the paragraphs into at least one passage;
creating at least one index, each index including a passage-identifier and a word-number identifier;
wherein the at least one passage is a single passage when the document contains less than N paragraphs, wherein N is an integer greater than 1;
wherein each N consecutive paragraphs in said document are merged to form the at least on passage when the document contains at least N paragraphs, such that if the document contains more than N paragraphs the document will include respective passages having at least one identical paragraph.

14. The indexes on the computer-readable medium of claim 13, wherein if the document contains at least N paragraphs, merging the first N−1 consecutive paragraphs of said document to form a first passage of said document, relating said first passage with words in the first passage to form a first index of the at least one index, merging the last N−1 consecutive paragraphs of said document to form a last passage of said document, and relating said last passage with words in the last passage to form a last index of the at least one index.

15. The indexes on computer-readable medium 13, wherein N is from 2 to 30.

16. The indexes on computer-readable medium 14, wherein N is from 2 to 30.

17. The indexes on computer-readable medium of claim 15, wherein N is 6.

18. The indexes on computer-readable medium of claim 16, wherein N is 6.

19. A computer-readable medium including a program used to analyze a document including paragraphs and determine passages included in said document, said program comprising:
processing the document to group the paragraphs into at least one passage;
wherein the at least one passage is a single passage when the document contains less than N paragraphs, wherein N is an integer greater than 1;
wherein each N consecutive paragraphs in said document are merged to form the at least on passage when the document contains at least N paragraphs, such that if the document contains more than N paragraphs the document will include respective passages having at least one identical paragraph.

20. The computer-readable medium of claim 19, wherein if the document contains at least N paragraphs, merging the first N−1 consecutive paragraphs of said document to form a first passage of said document, and merging the last N−1 consecutive paragraphs to form a last passage of said document,
wherein when the document contains at least N paragraphs, at least three passages are formed in the document and the document will include respective passages having at least one identical paragraph.

21. The computer-readable medium of claim 19, wherein N is from 2 to 30.

22. The computer-readable medium of claim 20, wherein N is from 2 to 30.

23. The computer-readable medium of claim 21, wherein N is 6.

24. The computer-readable medium of claim 22, wherein N is 6.

25. A computer-readable medium including a program for forming indexes, said program analyzes a document including paragraphs, said program comprising:
processing the document to group the paragraphs into at least one passage;
creating at least one index, each index including a passage-identifier and a word-number identifier;
wherein the at least one passage is a single passage when the document contains less than N paragraphs, wherein N is an integer greater than 1;
wherein each N consecutive paragraphs in said document are merged to form the at least on passage when the document contains at least N paragraphs, such that if the document contains more than N paragraphs the document will include respective passages having at least one identical paragraph.

26. The computer-readable medium of claim 25, wherein if the document contains at least N paragraphs, merging the first N−1 consecutive paragraphs of said document to form a first passage of said document, relating said first passage of said document with words in the first passage to form a first index of the at least one index, merging the last N−1 consecutive paragraphs to form a last passage, and relating said last passage of said document with words in the last passage to form a last index of the at least one index.

27. The computer-readable medium of claim 25, wherein N is from 2 to 30.

28. The computer-readable medium of claim 26, wherein N is from 2 to 30.

29. The computer-readable medium of claim 27, wherein N is 6.

30. The computer-readable medium of claim 28, wherein N is 6.
